(19) United States
(12) Patent Application Publication
(10) Pub. No.: US 2015/0242917 A1
(43) Pub. Date: Aug. 27, 2015

(54) MICROPAYMENT COMPENSATION FOR USER-GENERATED GAME CONTENT

(71) Applicant: Google Inc., Mountai View, CA (US)

(72) Inventors: Duncan John Curtis, Castro Valley, CA (US); Alexander Ruben Stacey McCarthy, San Francisco, CA (US)

(73) Assignee: Google Inc., Mountai View, CA (US)

(21) Appl. No.: 14/188,221

(22) Filed: Feb. 24, 2014

(51) Int. Cl. G06Q 30/06; G06Q 30/02

(52) U.S. Cl. CPC G06Q 30/0613; G06Q 30/0242; G06Q 30/0276; G06Q 30/0282

(57) ABSTRACT

Implementations disclosed herein related to apportioning revenue to a content-creating user if that user's content assisted in the fulfillment of a purchase opportunity. User-generated content may be selected based on criteria, for example, that will likely lead to consummation of a purchase opportunity. Some of the revenue generated from the sale may be sent to the user whose content was associated with the sale. In this way, the user may be encouraged to generate more such content and be rewarded for the advertising the content provided.

### BACKGROUND

Many software platforms allow developers to sell software to users and, in some cases, allow consumers to make in-application purchases. A platform may refer to an application market place or mobile device store. It may include one or more applications of which some may require a purchase. The platform may include other content such as music, movies, books, etc. that may also be sold to users. A user may make a purchase of an application or other content while interfaced with the platform. In-application purchases may be made from within a particular application and the application may access the user's account on the platform to complete the transaction. The platform may secure a percentage of the revenue generated from sales of the application and the in-application purchases.

### BRIEF SUMMARY

According to an implementation of the disclosed subject matter, an indication of a purchase opportunity may be obtained for one of a consumer good, an application, and/or a content item. A video related to the purchase opportunity may be displayed in a purchase prompt for the purchase opportunity. The video may be generated by a user who is not purveyor of the purchase opportunity. An indication of revenue generated from fulfillment of the purchase opportunity may be received. A portion of the revenue may be sent to the user based on fulfillment of the purchase opportunity.

In an implementation, a system is provided that includes a content aggregation platform, an application, and a server. The content aggregation platform may be configured to store user-generated content and to provide the user generated content. The application may operate on a device that is physically distinct from the server and the content aggregation platform. It may be configured to provide an indication of a purchase opportunity for one of a consumer good, application, or content item. The application may request, from the server, a video related to the purchase opportunity in a purchase prompt for the purchase opportunity. The video may be generated by a user who is not the purveyor of the purchase opportunity. The application may receive an indicator of the video on the content aggregation platform. The application and/or the server may determine fulfillment of the purchase opportunity. The server may be configured to provide an indicator of the video on the content aggregation platform to the application in response to the request. It may receive an indication of revenue generated from fulfillment of the purchase opportunity and send a portion of the revenue to the user who created the video based on fulfillment of the purchase opportunity.

In an implementation an indication of a user interest in a purchase opportunity may be received. A purchase likelihood for the purchase opportunity for at least one of user-generated video on a content aggregation platform may be determined. A user-generated video on the content aggregation platform may be selected based on the purchase likelihood. The selected user-generated video may be displayed to the user in a purchase prompt for the purchase opportunity.

Systems and devices according to the present disclosure may include means for obtaining an indication of a purchase opportunity, displaying a video related to the purchase opportunity in a purchase prompt for the purchase opportunity, receiving an indication of revenue generated from fulfillment of the purchase opportunity, and sending a portion of the revenue to the user based on fulfilment of the purchase opportunity. In some configurations, systems and devices may include means for receiving an indication of a user interest in a purchase opportunity, determining a purchase likelihood for the purchase opportunity for at least one of a plurality of user-generated videos on a content aggregation platform, selecting one of the user-generated videos on the content aggregation platform based on the purchase likelihood and displaying the user-generated video in a purchase prompt to the user.

According to an implementation, a portion of revenue generated from fulfillment of a purchase opportunity may be provided to the creator of content that facilitated the purchase. Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3A is an example of a purchase prompt or purchase screen as disclosed herein.

FIG. 3B is an example system for sharing revenue with a content creator according to an implementation disclosed herein.

FIG. 4 is an example method for apportioning revenue to a content-creating user as disclosed herein.

FIG. 5 is an example system for apportioning revenue to a content-creating user if the user's content assisted in fulfillment of the purchase opportunity as disclosed herein.

FIG. 6 is an example process to select user-generated content for display in a purchase prompt for a purchase opportunity based on a purchase likelihood as disclosed herein.

### DETAILED DESCRIPTION

User-generated content, such as movie trailers, video game trailers, and the like, can have a substantial influence in application and in-application purchase decisions. For example, a video may show a user what a particular item in a game does or otherwise provide a user with an understanding of the general concept of a game. Such videos are often created by users of the application instead of developers, distributors, or other purveyors of the application. This user-generated content may encourage an otherwise uncertain purchaser to make a purchase of an application or in-application content. But, user-generated advertising content (e.g., video, audio, image, etc.) may not be compensated and, consequently, users may not be incentivized to manufacture such content or to continue to manufacture such content. Systems and techniques are disclosed herein in which users can generate content (e.g., videos, screenshots, trailers, etc.) for paid-developer-generated content. The system may automatically select the user-generated content for the purchase opportunity presented in the developer generated content that will likely result in a purchase, for example. User generated content may be selected based on other criteria such as popularity as well. The selection may be based on which user-generated content has the largest impact on developer content sales. The user responsible for the selected user-generated content may be compensated based on the revenue from fulfillment of the purchase opportunity. Thus, for application or in-application purchases, a creator of content (reviews, screenshots, videos, etc.) that can be utilized to advertise or promote the application may receive a portion of the revenue generated from sales in which the user-generated content was utilized.

As an example, a first user may particularly enjoy making videos of the first user's gameplay on game XYZ. A computer system may determine that showing the first user's video may increase the likelihood of a purchase of XYZ by a second user. The second user, upon watching the first user's video, may purchase XYZ. As compensation, the first user may receive a portion of the revenue generated from the sale of XYZ to the second user. Similarly, the first user may make a video for an in-application purchase of a power-up, for example, for game XYZ. An offer for the power-up may be presented to the second user which contains the first user's video for the power-up. As before, the second user may decide to purchase the power-up. The first user may receive a portion generated from the sale of the power-up.

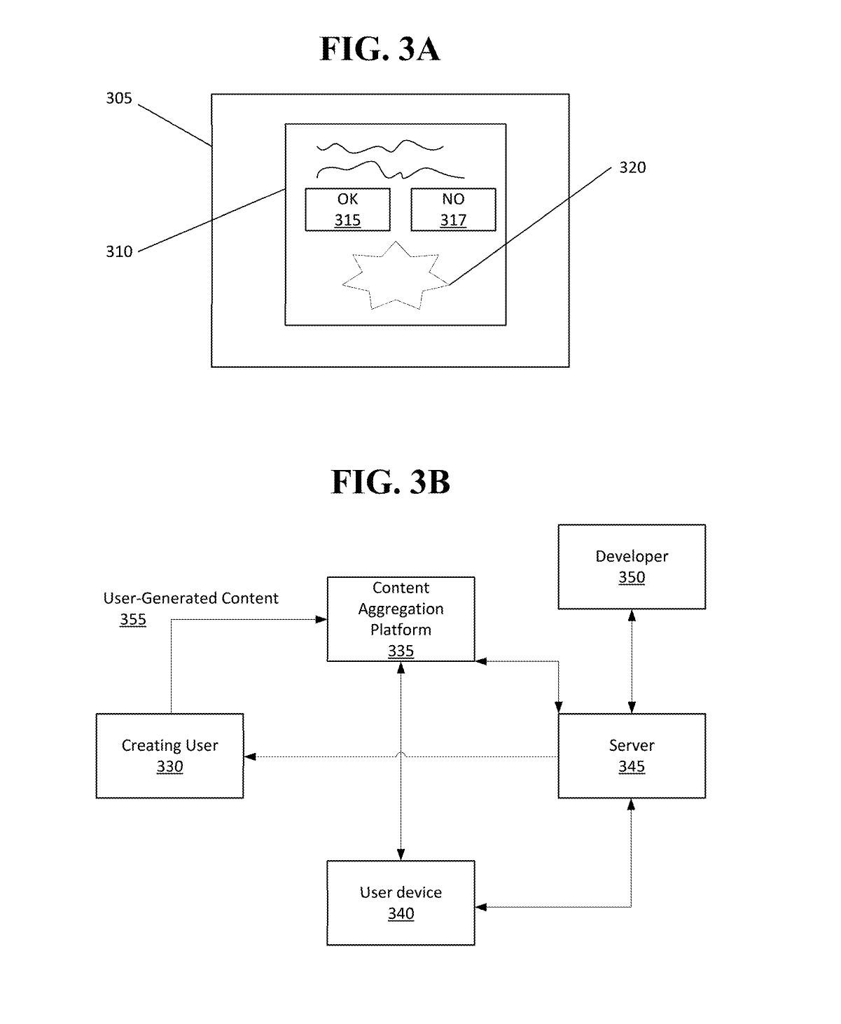

FIG. 3A is an example of how user-generated content may be shown to a prospective purchaser. The screen 305 of a computing device is shown. A purchase prompt 310, such as a pop-up window, may show an offer to purchase an application or other content. The user may be presented with options to accept the purchase (“OK”) 315 or to decline the purchase (“NO”) 317. To assist the user, the pop-up window (i.e., a payment screen) 310 may show a video 320 from a content creator (i.e., not the application developer) who has made at least one video about the application. The video 320 may have been selected because of its popularity, for example.

In some instances, the systems and methods disclosed herein may be applied to consumer goods. For example, a user may travel frequently and generate video reviews of places the user has visited and services the user engaged while at those places (e.g., hotels, restaurants, shops, etc.). Other users may view the videos uploaded and search for plane tickets to the locales visited by the user. A portion of the revenue generated from other users' visits to the locale based on the user's videos may be provided to the video creator. Similarly, product reviews may encourage purchase of a product. A reviewer may receive a portion of revenue generated from sales of a product for which the reviewer's content was shown to the purchaser. Thus, developers and other purveyors of consumer goods, products, and/or services may generate more revenue and content creators may be incentivized to continue generating content that can help the former.

FIG. 3B is an example system for sharing revenue with a content creator according to an implementation disclosed herein. A user 330 may upload user-generated content 355 to a content aggregation platform 335. User generated content 355 may refer to a video, a screenshot, an image, audio, a review, etc. The content aggregation platform 335 may be a video hosting website, for example. Information about the content provided on the content aggregation platform may be made to the server 345 and/or the server 345 may extract information from content aggregation platform 335. For example, information about content on the content aggregation 335 platform may include: a number of views of one or more pieces of content per time period of time, a universal resource identifier, a popularity metric, an identity of one or more users who visited a particular piece of content, demographic information for content (e.g., age of viewers, nationality of viewers, time of viewings, etc.), data analytics for content (e.g., word usage, n-grams, histogram of gradients, pixel intensity, size, resolution, length, format, audio content (e.g., audio to text), etc.), user comments on content, a content-creator's description of content the creator made, etc. The information obtained or extracted from the content aggregation platform 335 may be subjected to further analysis by the server (or computer system) 345 to extract or reveal trends, correlations, or other associations.

A user device 340 may be communicatively coupled to the content aggregation platform 335 and/or the server 345. The user device 340 may be a smartphone, a tablet, a laptop, etc. The server 345 may be an application repository, an application store, or be responsible for hosting one or more applications, for example. A developer 350 may upload an application or other content 360 to the server 345. The server may communicate, for example, bug reports or errors associated with the content the developer has uploaded, or share revenue generated from sales of developer's content (e.g., in game purchases or application purchases). In configurations in which the server 345 is an application marketplace or store, users may connect to the application store and download applications or other content (e.g., books, movies, music, etc.) to the user's device 340. The application on the user's device 340 may continue to communicate with the server 345 periodically (e.g., to obtain updates, for in-application purchases, to send user inputs and/or analytic data, etc.). The user may be presented with a purchase screen (see, for example, FIG. 3A) for an item in the application.

The server 345 may determine, based on information obtained from the content aggregation platform 335, that a particular video review of the item the user is contemplating purchasing is associated with purchase of the item. Determinations of which content is to be shown in the purchase screen may be updated and may be tailored to a particular user. The server 345 may direct the purchase screen to show the review video. The server 345 may have made the determination based on the popularity of the video and the number of instances in which a user presented with the screen performs a search in a web browser on the user's device 340 for the particular item, views the review video, and proceeds with the purchase. As stated earlier, other criteria may be used in place of or in addition to those described here. Thus, one or more videos may be identified as being related to the purchase opportunity. The videos may be ranked based on predefined criteria and/or developer-provided criteria. The highest ranked video may be selected as the one shown in the purchase prompt. For example, predefined criteria such as popularity (as determined by the number of views of the video) and the number of instances in which viewing of a video coincided with a purchase of an item in an application. Each of these criteria may be converted to a score. For example, popularity may be assigned a score based on the number of views divided by the number of days the video has been public.

The review video in the purchase screen on the user's device 340 may be obtained directly from the content aggregation platform 335 by the user's device 340. For example, the server 340 may provide the URI for the video and the application may query the content aggregation platform 335 with the URI to display the video in the purchase screen. Upon completing a purchase on the user's device 340, the server may receive an indication of the purchase fulfillment and apportion the revenue generated therefrom. For example, the owner of the server 345 may receive a portion of the revenue, the developer 350 may receive a portion of the revenue, and the user 330 whose content was shown in the purchase screen of the consummated purchase may receive a portion of the sale.

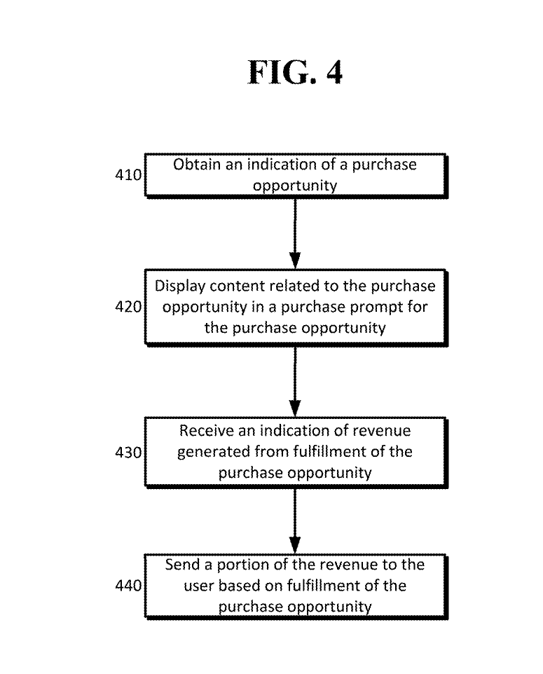

In an implementation, as shown by the example in FIG. 4, an indication of a purchase opportunity for an item such as a consumer good, an application, or a content item may be obtained at 410. A purchase opportunity, for example, may be an offer for an in-application purchase (e.g., a power-up item), a user-initiated purchase (e.g., a user selecting an application to buy from an application marketplace), etc. A video related to the purchase opportunity may be displayed in a purchase prompt for the purchase opportunity 420. Other content, such as audio, one or more images, a review, etc. may be shown in the purchase prompt in addition to or in lieu of a video. The type of content notwithstanding, the content may be generated by a user who is not the purveyor of the purchase opportunity. A purveyor of a purchase opportunity may be, for example, a developer whose application is operated on a user device and causes an in-application purchase prompt to be generated. Similarly, a purveyor of a purchase opportunity may be an application marketplace or other distributor that provides a purchase prompt for a user to make an application purchase. For example, a user, who is not the developer of the application for which the purchase prompt has appeared, may have generated a video related to the application. The user's content may be hosted at a location distinct from the application marketplace, such as a content aggregation platform as described earlier. Content shown in the purchase prompt may be selected based on, for example, a correlation between the content and a purchase related to the item shown in the purchase prompt (e.g., an application, a consumer good, a content item). The purveyor of the purchase opportunity may provide an indication of content to be shown in the purchase prompt. For example, a developer for a game application may find that a set of users show off the game better than others, even though those users' content may not be the most popular. The developer may inform the marketplace to select content from among that set of users. Thus, the purveyor of a purchase opportunity is distinct from the user who has generated a video related to the purchase opportunity. More than one entity may be deemed a purveyor of a purchase opportunity. For example, a developer and an application marketplace may be deemed a purveyor of a purchase opportunity that appears for a purchase prompt for an application purchase for which the developer is the creator of the application.

An indication of revenue generated from fulfillment of the purchase opportunity may be received at 430. For example a user may have an account associated with an application marketplace and from which the user downloaded an application. The user, upon being prompted with a purchase prompt for an in-application purchase, may enter credit card information or other identifying information to transact the purchase. The application may direct communication of the payment information to the application marketplace. The application marketplace may debit the user's account in the appropriate amount and credit itself, the developer, and the user whose content was shown to the purchasing user. Thus, a portion of the revenue may be sent to the user based on fulfilment of the purchase opportunity 440. Apportionment of revenue generated from a sale may vary as between different content creators and developers.

In some configurations, the system may be implemented in such a manner so as to augment a user's search for a consumer good. For example, a user may be browsing vacuum cleaners. Image recognition may be employed to determine the models of the vacuum cleaners being presented to the user. The user may be presented with a prompt screen that asks the user if the user would like to see a video review of a particular vacuum cleaner model. Thus, in some configurations, the identity of a consumer good, an application or a content item may be determined based on an analysis of what a user is currently showing on a web browser, for example.

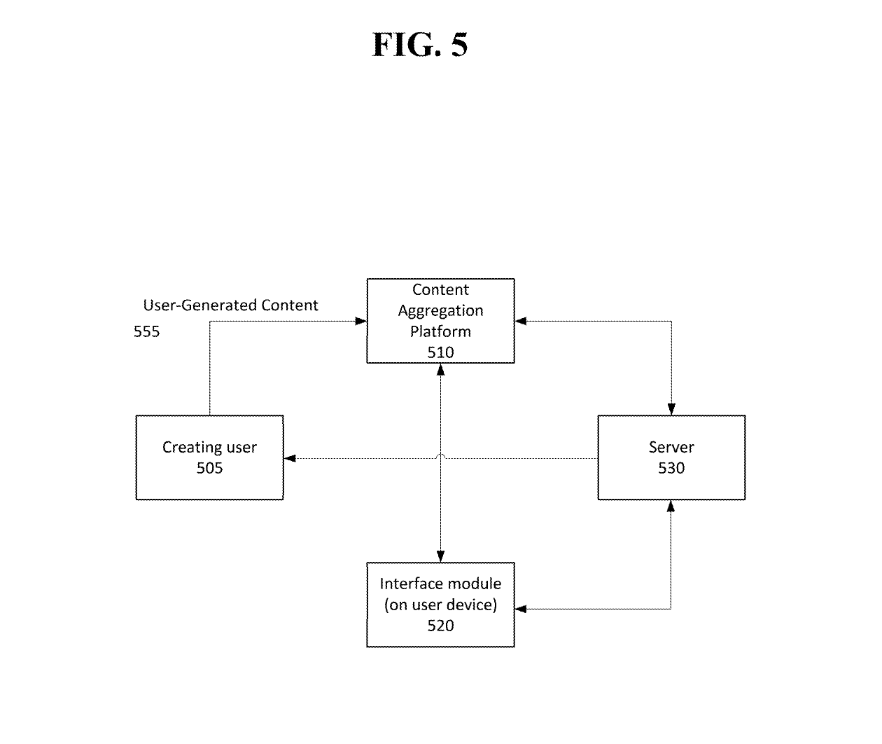

A system, as shown by the example shown in FIG. 5, is provided in an implementation that includes a content aggregation platform 510, an interface module 520, and a server 530. The content aggregation platform 520 may be configured to receive, store, and/or provide user-generated content 555 as described earlier. The interface module 520 may interface with the content aggregation platform 510 and the server 530 directly. For example, the interface module 520 may be used to browse content hosted on the server 530 and/or consume content on the content aggregation 510 platform. It may be configured to provide an indication of a purchase opportunity for an item such as a consumer good, application, or content item to, for example, the server. The interface module 520 may request, from a server, a video (or other user-generated content) related to the purchase opportunity in a purchase prompt for the purchase opportunity. The video may be generated by a user 505 who is not the purveyor of the purchase opportunity as described above. An indication of the video or its location on the content aggregation platform 510 may be received by the application. The interface module 520 may be run or executed on a user device that is physically distinct from the server and the content aggregation platform. The server 530 may be configured to provide an indicator of the video on the content aggregation platform 510 to the interface module 520 in response to the request. As described earlier, the server 530 may receive an indication of revenue generated from fulfillment of the purchase opportunity and send a portion of the revenue to the user 505 who created the video based on fulfillment of the purchase opportunity.

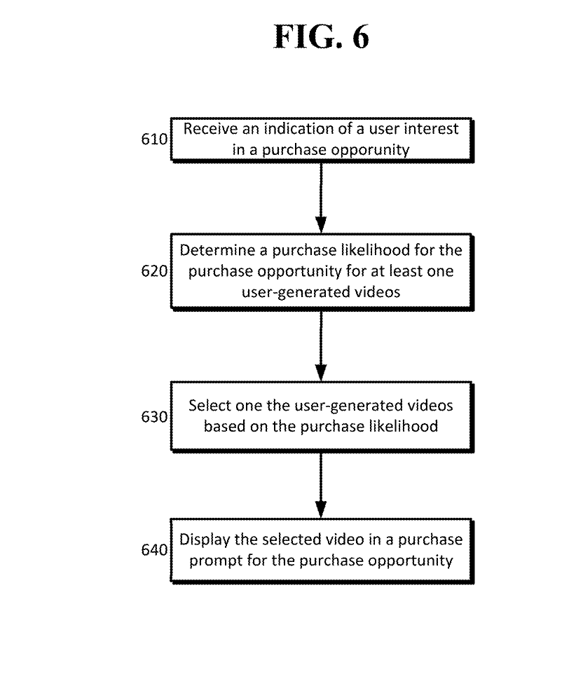

In an implementation, an example of which is shown in FIG. 6, an indication of a user interest in a purchase opportunity may be received at 610. An indication of a user interest may refer to, for example, a user request for more information about an application or an in-application item. A user browsing content on an application marketplace may select one of the pieces of content shown to the user. Selection of the content may navigate the user to a webpage, for example, that contains additional information about the content. If the content is a movie, for example, the information page about the movie may contain user reviews, cast information, a plot synopsis, a user rating, movie trailers, etc. An indication of a user interest may refer to a request to purchase. For example, a user may click on a purchase link for an application. The purchase link may cause a purchase prompt, as described earlier, to appear. User-generated content such as a video may appear in this purchase prompt as disclosed herein. A purchase opportunity may refer to an offer to buy digital content, in-application purchases (e.g., a power-up item for a video game), and/or a consumer good as described earlier.

A purchase likelihood for the purchase opportunity for at least one user-generated video on a content aggregation platform may be determined at 620. One or more videos may be stored on a content aggregation platform. For example, the content aggregation platform may be a website at which users may upload personal videos (e.g., user-generated content) or view such content of other users. Purchase likelihood values determined for one or more user-generated videos may be ranked, for example, for a particular item.

A purchase likelihood may refer to a number of instances in which a conversion event (i.e., fulfillment of the purchase opportunity) occurs for a purchase opportunity divided by the number of instances in which a video is shown in a purchase prompt or the number of views on the content aggregation platform. The purchase likelihood may refer to a probability that the user will fulfill the purchase opportunity upon viewing a particular item of user-generated content. For example, a system as disclosed herein may initially test multiple videos to users based on a popularity cut-off or threshold by including the video in a series of purchase prompts as previously disclosed, and determining whether a purchase results from each prompt. The purchase likelihood may be based on the number of instances in which users completed the purchase subsequent to viewing the content. This does not, however, preclude those videos that did not have the highest conversion rate (or purchase likelihood) from being shown. For example, a user-specified preference may result in one of the video's being shown that did not have the highest purchase likelihood from culled group (e.g., those videos selected based on popularity). Thus, the purchase likelihood may refer to a probability that a particular user will fulfill the purchase opportunity upon viewing a user-generated video.

In some implementations, a purchase likelihood may be based on a user characteristic. For example, a user profile which may contain an indication of user characteristics such as: a user's interests, demographic information about the user, a user's preference, a purchase history, a browsing history, etc. may be used to cluster the user with other users that have similar profiles, such as users that share the same attributes described by the user profiles. A purchase opportunity may be shown in which users from a given cluster are shown different videos in the purchase prompt. Based on the number of instances in which users in this testing convert the purchase opportunity, a purchase likelihood may be assigned to the cluster for a particular video. That video may be the one selected for all members of the cluster in subsequent purchase prompts for the particular item. A user characteristic may be determined based on a clustering. For example, if a user profile indicates characteristics A, B, and C and this causes the user to be associated with cluster ABCD. The characteristic “D” may be associated with the user's profile unless and until an indication that this is incorrect is received.

A purchase likelihood can be determined for one or more videos on a content aggregation platform that are associated with an item or application, for example. In some configurations, multiple content aggregation platforms may provide source material for purchase opportunities. For example, a purchase likelihood may be determined from videos uploaded to two separate content aggregation platforms. One video may be selected for display in the purchase prompt as disclosed herein. A purchase likelihood may not be determined for all videos on a content aggregation platform. For example, it may not be efficient to determine a purchase likelihood for a video that is disliked by a majority of users. A purchase likelihood may not be calculated for such unpopular videos. Likewise, a video whose content is unrelated to the item for which the purchase prompt has appeared may not have a purchase likelihood determined.

The video may be deemed related to each item, for example, based on comments in which the item is mentioned, an analysis of the video in which the item is determined to be displayed in one or more frames of the video, an analysis of an audio track associated with the video in which the item is mentioned. Other mechanisms of determining whether user-generated content is related to a purchase opportunity described herein and/or known to those skilled in the art may be utilized according to any implementation disclosed. For example, a developer may indicate a preference for videos from a particular content generator. The determination of the purchase likelihood may, accordingly, weight videos from that particular content generator such that they are more likely to be ranked higher. Similarly, the purchase likelihood may be based on a user's preference. A user, to whom the purchase prompt has appeared, may be determined to like a particular genre of music or videos of a certain length. Content creators who use music from that genre may have their videos weighted more favorably (e.g., a higher likelihood of being selected). Any or all of the aforementioned criteria (e.g., developer specified preference and user-specified preference with respect to video content) and other like criteria known in the art may be used to select a video for presentation with the purchase prompt.

A user-generated video may have more than one purchase likelihood. For example, a video may present features for multiple items of a game or discuss multiple applications. A purchase likelihood may be calculated for each specific item or application. If a video mentions in-application items A and B, a purchase likelihood for item A for the video may be 35% and that of B may be 56%. Purchase likelihood values may be dynamic. Continuing the example, the purchase likelihood of the video may be 45% for item A and 40% for item B two years later. The purchase likelihood may be calculated ad hoc, such as at the time the purchase prompt for the digital content item, consumer good, or in-application purchase appears, periodically, or at the request of a developer, for example.

One of the user-generated videos on the content aggregation platform may be selected based on the purchase likelihood at 630. As described above, the determined purchase likelihood for each of the videos related to the item or those videos preselected to have a purchase likelihood determined (e.g., based on popularity) may be determined, for example, relative to a particular user, a cluster of user's, or based on all users. The selected user-generated video may be displayed in a purchase prompt for the purchase opportunity to the user at 640. Implementations of the presently disclosed subject matter may be implemented in and used with a variety of component and network architectures.

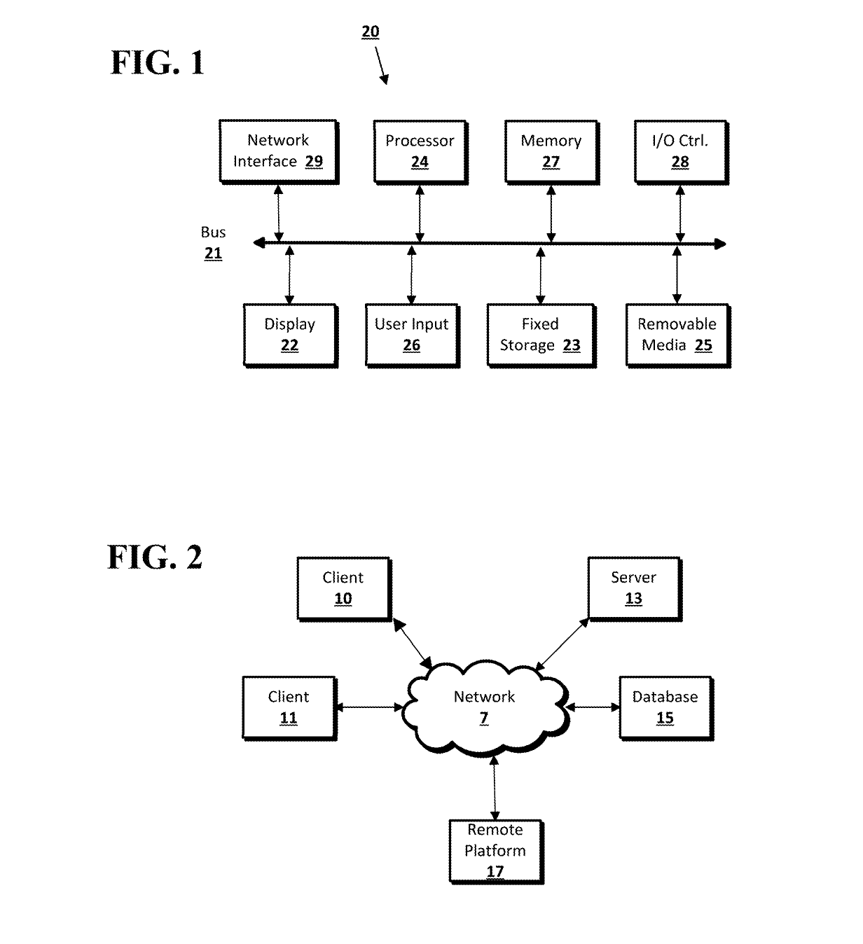

FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's performance score, a user's work product, a user's provided input, a user's geographic location, and any other similar data associated with a user), or to control whether and/or how to receive instructional course content from the instructional course provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with an instructional course may be generalized where location information is obtained (such as to a city, ZIP code, or state level), so that a particular location of a user cannot be determined. Thus, the user may have control over how information is collected about the user and used by an instructional course provider.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
obtaining an indication of a purchase opportunity for at least one selected from the group consisting of: a consumer good, an application, and a content item;
displaying a video related to the purchase opportunity in a purchase prompt for the purchase opportunity, wherein the video is generated by a user who is not a purveyor of the purchase opportunity;
receiving an indication of revenue generated from fulfillment of the purchase opportunity; and
sending a portion of the revenue to the user based on fulfilment of the purchase opportunity.

2. The method of claim 1, further comprising automatically selecting the video related to the purchase opportunity from among a plurality of videos stored by a video hosting site and related to the purchase opportunity.

3. The method of claim 2, further comprising automatically selecting the video related to the purchase opportunity based on a ranking of the video related to the purchase opportunity at the video hosting site.

4. The method of claim 3, wherein the ranking comprises a popularity ranking.

5. The method of claim 3, wherein the ranking comprises a number of views of the video related to the purchase opportunity at the video hosting site.

6. The method of claim 1, further comprising determining a correlation between each of a plurality of videos related to the purchase opportunity and fulfillment of the purchase opportunity.

7. The method of claim 3, further comprising selecting at least one of the plurality of videos based on the correlation.

8. The method of claim 1, further comprising:
determining an identity of the consumer good, application, or content item; and
selecting the video based on the identity of the consumer good, application, or content item.

9. The method of claim 1, further comprising receiving a selection criterion from the purveyor of the purchase opportunity, wherein the video related to the purchase opportunity is selected based on the selection criterion.

10. A system, comprising:
a content aggregation platform configured to:
store user-generated content; and
provide the user-generated content;
an interface module configured to:
provide an indication of a purchase opportunity for at least one selected from the group consisting of a consumer good, an application, and a content item;
generate a request for a video related to the purchase opportunity in a purchase prompt for the purchase opportunity, wherein the video is generated by a user who is not a purveyor of the purchase opportunity;
receive an indicator of the video on the content aggregation platform; and
a server configured to:
receive the request for the video related to the purchase opportunity;
provide an indicator of the video on the content aggregation platform to the interface module in response to the request;
receive an indication of revenue generated from fulfillment of the purchase opportunity; and
send a portion of the revenue to the user who created the video based on fulfillment of the purchase opportunity.

11. The system of claim 10, the server further configured to automatically select the video related to the purchase opportunity from among a plurality of videos stored on the content aggregation platform.

12. The system of claim 10, the server further configured to automatically select the video related to the purchase opportunity based on a ranking of the video related to the purchase opportunity on the content aggregation platform.

13. The system of claim 12, wherein the ranking comprises a popularity ranking.

14. The system of claim 12, wherein the ranking comprises a number of views of the video related to the purchase opportunity at content aggregation platform.

15. The system of claim 10, the server further configured to determine a correlation between each of a plurality of videos related to the purchase opportunity and fulfillment of the purchase opportunity.

16. The system of claim 12, the server further configured to select at least one of the plurality of videos based on the correlation.

17. The system of claim 10, the server further configured to:
determine an identity of the consumer good, application, or content item;
select the video based on the identity of the consumer good, application, or content item.

18. The system of claim 10, the server further configured to receive a selection criterion from the purveyor of the purchase opportunity, wherein the video related to the purchase opportunity is selected based on the selection criterion.

19. The system of claim 10, wherein the interface module operates on a device that is physically distinct from the server and the content aggregation platform.

20. A method, comprising:
receiving an indication of a user interest in a purchase opportunity;
determining a purchase likelihood for the purchase opportunity for at least one of a plurality of user-generated videos on a content aggregation platform;
selecting, one of the plurality of user-generated videos on the content aggregation platform based on the purchase likelihood; and
displaying the one of the plurality of user-generated videos in a purchase prompt for the purchase opportunity to the user.

21. The method of claim 20, wherein the purchase likelihood comprises a probability that the user will fulfill the purchase opportunity upon viewing the one of the plurality of user-generated videos.

22. The method of claim 21, wherein the purchase likelihood for the purchase opportunity is based on at least one user characteristic.

23. The method of claim 22, wherein the at least one user characteristic is selected from the group consisting of: a purchase history, a browsing history, a user demographic, a user preference.

24. The method of claim 22, wherein the at least one user characteristic is based on a clustering of the user based on the at least one user characteristic with a plurality of users.

25. The method of claim 21, further comprising ranking the plurality of user-generated videos based on the purchase likelihood for the user.

26. The method of claim 20, wherein the purchase likelihood comprises a probability that a video will result in fulfillment of the purchase opportunity.
